(19) United States
(12) Patent Application Publication
(10) Pub. No.: US 2024/0287662 A1
(43) Pub. Date: Aug. 29, 2024

(54) PRECIPITATION HARDENING TYPE SOFT MAGNETIC FERRITIC STAINLESS STEEL HAVING EXCELLENT MACHINABILITY

(71) Applicant: TOHOKU STEEL CO., LTD., Shibata-gun, Miyagi (JP)

(72) Inventors: Masahito WATANABE, Shibata-gun (JP); Takuma MIYANO, Shibata-gun (JP); Tatsuya NARUSE, Shibata-gun (JP); Naoyuki OWARI, Shibata-gun (JP); Takenobu SATO, Shibata-gun (JP); Takashi EBATA, Shibata-gun (JP)

(73) Assignee: TOHOKU STEEL CO., LTD., Shibata-gun, Miyagi (JP)

(21) Appl. No.: 18/693,417

(22) PCT Filed: Jul. 10, 2023
(86) PCT No.: PCT/JP2023/025371

§ 371 Date: Mar. 19, 2024

(30) Foreign Application Priority Data
Jul. 12, 2022 (JP) 2022-111765

(51) Int. Cl. C22C 38/40; C21D 6/02; C22C 38/00; C22C 38/04; C22C 38/06; C22C 38/34

(52) U.S. Cl. CPC C22C 38/40; C21D 6/02; C22C 38/002; C22C 38/04; C22C 38/06; C22C 38/34; C21D 2211/005; C22C 2202/02

(57) ABSTRACT

A precipitation hardening type soft magnetic ferritic stainless steel having an excellent machinability contains, in % by mass, C: 0.1% or less (excluding 0%), Si: 0.01 to 2.5%, Mn: 0.5% or less (excluding 0%), S: 0.1% or less (excluding 0%), Cr: 12.0 to 19.0%, Ni: 1.0 to 4.0%, Al: 0.5 to 3.0%, and at least one of Ti: 0.05 to less than 0.5% and Zr: 0.05 to less than 0.3%, as well as Bi: 0.02 to 0.5%, in which a remainder includes inevitable impurities and substantially is made of Fe, and the stainless steel has a structure substantially in a ferrite phase after solution annealing and aging, and a hardness of 300 Hv or higher after aging. The precipitation hardening type soft magnetic ferritic stainless steel is excellent in soft magnetic properties, age-hardenability, and corrosion resistance, as well as machinability.

### FIELD OF THE INVENTION

The present invention relates to a precipitation hardening type soft magnetic ferritic stainless steel, more specifically a precipitation hardening type soft magnetic ferritic stainless steel having excellent soft magnetic properties and corrosion resistance as well as good machinability.

### DESCRIPTION OF RELATED ART

Soft magnetic ferritic stainless steels have been widely used as magnetic core materials for various solenoid valves, electronically controlled fuel injection devices, and the like, because magnetic properties and corrosion resistance have been demanded. A precipitation hardening type soft magnetic ferritic stainless steel has been developed by the applicants of the present invention for the purpose of improving wear resistance and buckling resistance of sliding portions and collision portions of devices (see Patent Literature 1). This precipitation hardening type soft magnetic ferritic stainless steel has a hardness of 200 Hv or higher even in a solution-annealed state owing to a solid-solution strengthening effect of Ni, Al, Si, and the like.

### CITATION LIST

Patent Literature 1: JP Patent No. 3550132

### SUMMARY OF THE INVENTION

However, the precipitation hardening type soft magnetic ferritic stainless steel described in Patent Document 1 has a problem of poor machinability (including chip crushability), which has increased the cost in machining parts. Thus, a precipitation hardening type soft magnetic ferritic stainless steel with improved machinability without losing the characteristics such as soft magnetic properties, age-hardenability, and corrosion resistance has been demanded.

The present invention has been made with a focus on the above problem, and an object of the present invention is to provide a precipitation hardening type soft magnetic ferritic stainless steel excellent in soft magnetic properties, age-hardenability, and corrosion resistance, as well as machinability.

Although several additives for improving machinability are known, Bi has not been considered as an additive for improving machinability of soft magnetic ferritic stainless steels in the industry because Bi causes deterioration of soft magnetic properties and corrosion resistance. The present inventors have found that addition of an appropriate amount of Bi improves machinability without deteriorating soft magnetic properties, aged hardness, and corrosion resistance, and this finding has led to the present invention.

That is, the precipitation hardening type soft magnetic ferritic stainless steel having excellent machinability according to the first aspect of the present invention contains, in % by mass, C: 0.1% or less (excluding 0%), Si: 0.01 to 2.5%, Mn: 0.5% or less (excluding 0%), S: 0.1% or less (excluding 0%), Cr: 12.0 to 19.0%, Ni: 1.0 to 4.0%, Al: 0.5 to 3.0%, and at least one of Ti: 0.05 to less than 0.5% and Zr: 0.05 to less than 0.3%, as well as Bi: 0.02 to 0.5%, in which a remainder contains inevitable impurities and substantially consists of Fe, and the stainless steel has a structure substantially in a ferrite phase after solution annealing and aging, and a hardness of 300 Hv or higher after aging.

The precipitation hardening type soft magnetic ferritic stainless steel having excellent machinability according to the second aspect of the present invention contains, in % by mass, C: 0.1% or less (excluding 0%), Si: 0.01 to 2.5%, Mn: 0.5% or less (excluding 0%), S: 0.1% or less (excluding 0%), Cr: 12.0 to 19.0%, Ni: 1.0 to 4.0%, Al: 0.5 to 3.0%, and at least one of Ti: 0.05 to less than 0.5% and Zr: 0.05 to less than 0.3%, as well as Bi: 0.02 to 0.5%, and further contains at least one of Nb: 1.0% or less, Mo: 4.0% or less, Cu: 2.0% or less, B: 0.01% or less, and a remainder (REM): 0.1% or less, in which the remainder contains inevitable impurities and substantially consists of Fe, and the stainless steel has a structure substantially in a ferrite phase after solution annealing and aging, and a hardness of 300 Hv or higher after aging.

The present invention makes it possible to provide a precipitation hardening type soft magnetic ferritic stainless steel excellent in soft magnetic properties, age-hardenability, and corrosion resistance, as well as machinability.

### BRIEF DESCRIPTION OF THE DRAWINGS

FIG. 1 is an explanatory diagram illustrating a cutting resistance test method in Examples of the present invention.

FIG. 2 is a photograph presenting appearances of chips obtained by a chip crushing test in Examples of the present invention.

### DETAILED DESCRIPTION OF THE INVENTION

A reason why the ingredient composition in the steel was limited to the scope of claims will be explained. Note that the simple description “%” in the present specification means “% by mass”.

### C: 0.1% or Less (Excluding 0%)

Since C is an austenite stabilization element that inhibits production of a steel structure based on a ferrite phase and also adversely affects magnetic properties, it is desirable to minimize the C content. The C content was set to 0.1% or less in consideration of fixation of C as a carbide or a carbosulfide by Ti, Zr, or Nb, and producibility of steel.

### Si: 0.01 to 2.5%

Si is a ferrite stabilization element and contributes to improvement of soft magnetic properties owing to decreased coercivity or the like. Also, Si is effective for improving a high frequency responsiveness by increasing electrical resistivity. Since Si is also useful as a deoxidizer in manufacturing stainless steel, the Si content was set to 0.01% or more. However, when the Si content is around 3%, Si inhibits plastic workability in a cold process, and therefore the Si content was set to 2.5% or less.

### Mn: 0.5% or Less (Excluding 0%)

Mn is an element contained in stainless steel and useful as a deoxidizer, and also has effects of fixing S as a sulfide and further improving machinability. However, since Mn is an austenite stabilization element, Mn in an excessive addition amount of more than 0.5% destabilizes the ferrite phase. Furthermore, Mn inhibits magnetic properties and corrosion resistance, and therefore the Mn content was set to 0.5% or less. The lower limit of the Mn content is not particularly limited, but the content is preferably set to 0.05% or more in terms of exhibiting the above effects remarkably.

### S: 0.1% or Less (Excluding 0%)

Since S also has an effect of improving machinability by producing sulfides with Mn or the like and meanwhile deteriorates soft magnetic properties, S is added to such an extent that the influence is not remarkable in the present invention, and the S content is minimized. However, since S can be fixed by Mn, Ti, and Zr, the S content may be 0.01% or more, and therefore the S content was set to 0.1% or less.

### Cr: 12.0 to 19.0%

Cr is one of main ingredients in ferritic stainless steel and is an element effective for stabilizing the ferrite phase, improving corrosion resistance, and increasing a specific resistance. However, when the Cr content is less than 12%, the aforementioned effects are poor, and when the Cr content is more than 19%, the influence of inhibiting the soft magnetic properties is increased, and therefore the Cr content was set to 12.0 to 19.0%.

### Ni: 1.0 to 4.0%

As an intermetallic compound, Ni precipitates together with Al into steel by an aging heat treatment to increase a hardness of the steel. To achieve this effect, the Ni content must be 1.0% or more, but when an excessive amount of Ni is added, a martensite phase and an austenite phase are readily produced, and therefore the Ni content was set to 1.0 to 4.0%.

### Al: 0.5 to 3.0%

As an intermetallic compound, Al precipitates together with Ni into steel to increase a hardness of the steel, and usefully serves as a deoxidizer. Furthermore, Al has a ferrite stabilizing effect. When Al is added in a larger amount than the amount for forming the intermetallic compound together with Ni, Al contributes to decrease in the coercivity and increase in the specific resistance and exhibits an effect of improving high-frequency responsiveness, and therefore the Al content was set to 0.5% or more. However, excessive addition amount also inhibits cold workability and increases oxide inclusions, and therefore the upper limit of the addition amount was set to 3.0%.

At Least One of Ti: 0.05 to Less than 0.5% and Zr: 0.05 to Less than 0.3%

Ti and Zr are elements that effectively act to enhance magnetic properties and corrosion resistance by fixing C and S. However, an excessive addition amount of these elements deteriorates cold workability, and therefore the Ti content was set to 0.05 to less than 0.5%, and the Zr content was set to 0.05 to less than 0.3%.

### Bi: 0.02 to 0.5%

Bi is dispersed in steel to decrease a cutting resistance after solution annealing and also improve a chip crushability with almost no degradation of soft magnetic properties, age-hardenability, and corrosion resistance. Thus, Bi has an effect of improving machinability, and therefore the Bi content was set to 0.02% or more. An excessive addition amount of Bi deteriorates the soft magnetic properties and corrosion resistance, and therefore the upper limit of the addition amount was set to 0.5%.

The remainder includes inevitable impurities and substantially consists of Fe, and it is preferable that the Fe content in the remainder is 70 to 80%. The content of the inevitable impurities is preferably 0.1% by mass or less, particularly preferably 0.05% by mass or less. Examples of the inevitable impurities include P, N, and O.

The stainless steel may further include at least one of Nb: 1.0% or less, Mo: 4.0% or less, Cu: 2.0% or less, B: 0.01% or less, and REM: 0.1% or less.

### Nb: 1.0% or Less

Nb is an element effective for fixing C to improve the soft magnetic properties and corrosion resistance, and if contained, the Nb content is preferably 0.001% to 1.0%. An excessive addition amount of Nb rather inhibits the soft magnetic properties, and therefore the upper limit of the addition amount was set to 1.0%.

### Mo: 4.0% or Less

Mo is an element effective for improving the corrosion resistance, and if contained, the Mo content is preferably 0.05 to 4.0%. An excessive addition amount of Mo inhibits the cold workability, and therefore the upper limit of the addition amount was set to 4.0%.

### Cu: 2.0% or Less

Cu is an element effective for improving the corrosion resistance and also contributes to an aging effect, and if contained, the Cu content is preferably 0.05 to 2.0%. An excessive addition amount of Cu embrittles the material and inhibits cold workability, and therefore the upper limit of the addition amount was set to 2.0%.

### B: 0.01% or Less

B contributes to improvement of the cold workability, and if contained, the B content is preferably 0.001 to 0.01%. An excessive addition amount of B rather inhibits cold workability, and therefore the upper limit of the addition amount was set to 0.01%.

### REM: 0.1% or Less

REM contributes to improvement of the cold workability, and if contained, the REM content is preferably 0.001 to 0.1%. An excessive addition amount of REM rather inhibits cold workability, and therefore the upper limit of the addition amount was set to 0.1%.

An example of the method for manufacturing the precipitation hardening type soft magnetic ferritic stainless steel excellent in machinability according to the present invention will be explained below.

First, a steel material composed of the above ingredients is melted, for example, in an induction melting furnace under argon atmosphere, then the material is ingot-formed, subsequently cogged at 1000 to 1150° C., made up as billets while removing oxide scales using a grinder, heated to 1000 to 1150° C., then hot-rolled to obtain a wire, bar, or plate-shaped material. After the hot rolling, the material may be subjected to annealing or solution annealing heat treatment at 750 to 1050° C. to remove a stress or adjust a microstructure.

Next, in the case of the wire material, a cold drawing and a bend straightening are performed at an area reduction rate of 10 to 30%, followed by solution annealing at 900 to 1050° C. In this case, a main purpose of the heat treatment is to remove a work distortion of the material. In the case of the bar or plate-shaped material, the surface of the material is cut, and then bend is cold-straightened to provide a material for machining parts.

When machining the parts, the parts may be cut, or cold-pressed before the cutting. After the machining, the parts are subjected to an age hardening treatment, but the parts may be annealed or solution-annealed before the age hardening treatment for the purpose of improving the soft magnetic properties of the parts.

### Examples

Each 7 kg of steel materials composed of various ingredients presented in Table 1 was melted under Ar stream and cast into a mold to produce an 80 mmφ ingot. Subsequently, each ingot was hot-forged at 1000 to 1150° C. to form a 16 mmφ round bar, machined by outer periphery turning until its outer diameter reached 13 mmφ, and subjected to low-temperature solution annealing at 950° C. for 10 min to prepare a sample for various tests.

The hardness, magnetic properties, corrosion resistance, cutting resistance, and chip crushability of the obtained samples (Examples: Sample No. 1 to No. 7, Comparative Examples: Sample No. 8 to No. 12) were examined. The results are presented in Table 2.

TABLE 1

| | Sample | Chemical ingredient [mass %] | | | | | | | | | | | | |
|---|---|---|---|---|---|---|---|---|---|---|---|---|---|---|
| Section | No. | C | Si | Mn | P | S | Cu | Ni | Cr | Al | Ti | Mo | Bi | Others |
| Examples | 1 | 0.018 | 0.97 | 0.24 | 0.018 | 0.021 | 0.34 | 2.56 | 15.08 | 0.76 | 0.12 | 1.22 | 0.20 | |
| | 2 | 0.002 | 0.96 | 0.03 | 0.016 | 0.023 | 0.40 | 1.96 | 12.04 | 0.81 | 0.10 | 1.76 | 0.18 | B: 0.005 |
| | 3 | 0.015 | 0.93 | 0.22 | 0.037 | 0.017 | 0.36 | 2.58 | 14.25 | 0.98 | 0.16 | 1.70 | 0.26 | REM: 0.04 |
| | 4 | 0.012 | 0.89 | 0.25 | 0.025 | 0.032 | 0.33 | 2.04 | 16.72 | 0.83 | 0.15 | 1.03 | 0.28 | Zr: 0.05 |
| | 5 | 0.015 | 0.45 | 0.20 | 0.033 | 0.060 | 0.39 | 1.96 | 13.10 | 1.60 | 0.17 | 0.50 | 0.15 | |
| | 6 | 0.014 | 0.98 | 0.23 | 0.025 | 0.016 | 0.37 | 2.59 | 14.26 | 1.06 | 0.17 | 1.72 | 0.04 | Nb: 0.05 |
| | 7 | 0.011 | 2.06 | 0.15 | 0.066 | 0.054 | 0.40 | 1.48 | 18.34 | 0.79 | 0.42 | 0.08 | 0.15 | |
| Comparative | 8 | 0.002 | 0.86 | 0.03 | 0.013 | 0.025 | 0.40 | 0.99 | 12.02 | 0.39 | 0.08 | 1.01 | — | |
| Examples | 9 | 0.016 | 0.94 | 0.20 | 0.011 | 0.026 | 0.39 | 4.51 | 11.98 | 1.18 | 0.10 | 0.03 | — | |
| | 10 | 0.015 | 0.94 | 0.21 | 0.037 | 0.016 | 0.36 | 2.59 | 14.23 | 1.01 | — | 1.71 | 0.22 | |
| | 11 | 0.025 | 1.04 | 0.27 | 0.029 | 0.166 | 0.11 | 0.29 | 17.38 | 0.19 | 0.41 | 0.27 | 0.13 | |
| | 12 | 0.013 | 0.99 | 0.24 | 0.026 | 0.022 | 0.37 | 2.59 | 14.23 | 1.05 | 0.16 | 1.74 | — | |

TABLE 2

| | | | | After | | | | | | | | |
|---|---|---|---|---|---|---|---|---|---|---|---|---|
| | | | | solution | | | | | | | | |
| | | Cold machining | | annealing | After solution annealing - aging | | | | | | | |
| | Sample | Cutting | Chip | Hardness | Hardness | Magnetic flux density [T] | | | | | Hc | Corrosion |
| Section | No. | resistance | shape | Hv5 | Hv5 | B2 | B5 | B10 | B25 | B50 | [A/cm] | resistance |
| Examples | 1 | 98 | Good | 223 | 349 | 0.37 | 0.84 | 1.00 | 1.12 | 1.24 | 0.73 | Good |
| | 2 | 90 | Good | 212 | 314 | 0.95 | 1.12 | 1.21 | 1.31 | 1.39 | 0.42 | Good |
| | 3 | 92 | Good | 224 | 363 | 0.44 | 0.91 | 1.05 | 1.18 | 1.27 | 1.15 | Good |
| | 4 | 96 | Good | 211 | 326 | 0.38 | 0.84 | 1.04 | 1.15 | 1.26 | 1.28 | Good |
| | 5 | 94 | Good | 227 | 353 | 0.85 | 1.10 | 1.18 | 1.28 | 1.38 | 0.77 | Good |
| | 6 | 99 | Good | 217 | 372 | 0.56 | 0.93 | 1.07 | 1.18 | 1.27 | 0.90 | Good |
| | 7 | 121 | Good | 270 | 355 | 0.39 | 0.77 | 0.91 | 1.06 | 1.20 | 1.08 | Good |
| Comparative | 8 | 95 | Good | 171 | 171 | 0.93 | 1.15 | 1.25 | 1.35 | 1.44 | 0.45 | Good |
| Examples | 9 | 135 | Poor | 231 | 382 | 0.08 | 0.24 | 0.46 | 0.67 | 1.01 | 3.81 | Poor |
| | 10 | 108 | Good | 215 | 375 | 0.19 | 0.56 | 0.84 | 1.10 | 1.24 | 1.39 | Poor |
| | 11 | 81 | Good | 175 | 177 | 0.38 | 0.84 | 1.04 | 1.15 | 1.33 | 1.35 | Good |
| | 12 | 100 | Poor | 217 | 360 | 0.56 | 0.93 | 1.07 | 1.18 | 1.27 | 0.88 | Good |

The magnetic properties were measured using a B—H loop tracer by a process in which a ring sample with an outer diameter of 13 mm, an inner diameter of 5.85 mm, and a thickness of 5 mm was prepared, which was heated in a vacuum furnace at 1050° C. for 2 hours, then solution-annealed by quenching with nitrogen gas, and subsequently aged at 550° C. for 3 hours. Furthermore, the hardness of the same sample was also measured.

The corrosion resistance was evaluated by a process in which a 12.4 mmφ round bar with a length 35 mm was heated in the same way as for the magnetic property evaluation sample and polished with #800 emery paper to prepare a sample, a 5% NaCl aqueous solution was sprayed to the sample at 35° C. for 48 hours, and then a degree of rusting on the surface of the sample was observed. The corrosion resistance was evaluated in two-class discrimination, in which cases where rusting did not occur or, if present, rusting locally and faintly appeared at the corners of the round bar ends were rated as “Good”, and other cases where rusting was evidently observed were rated as “Poor”.

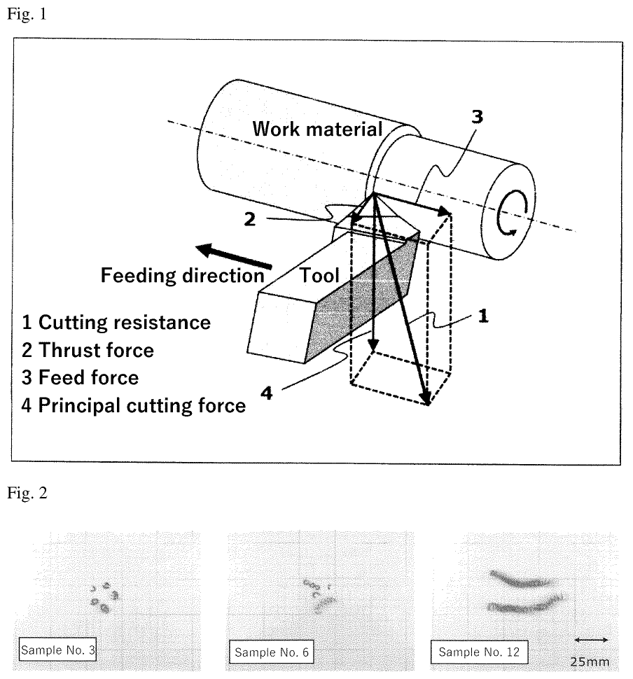

The cutting resistance was evaluated by a process in which a 12.6 mmφ sample with a length of 55 mm was prepared, and the sample was cut so as to have a projecting length of 35 mm and a width of 10 mm. The cutting was performed using a horizontal computerized numerical control (CNC) lathe with a tungalloy blade (TNMG331-SSAH310) under a lubricated condition with a mineral oil. The cutting conditions were set such that a cutting speed was 150 [mm/min], a feed rate was 0.15 [mm/rev], and a cutting depth was 0.5 [mm]. As illustrated in FIG. 1, the cutting resistance was defined as the resultant force of “thrust force, feed force, and principal cutting force” generated by outer periphery turning of the work material. Each sample was evaluated relative to the result defined as “100” of the comparative material sample No. 12 in Table 1.

The chip crushability was evaluated in two-class discrimination, in which cases where chips formed in the cutting resistance test were broken off at lengths of shorter than 25 mm were rated as “Good”, and cases of lengths of 25 mm or longer were rated as “Poor”. FIG. 2 presents an example of appearances of chips produced by the cutting.

From the results shown in Table 2, all of samples No. 1 to No. 7 were confirmed to have excellent cutting properties and corrosion resistance, a post-aging hardness of 310 HV5 or higher, and good magnetic properties. Examples showed a slightly better cutting resistance than in Comparative Examples. As presented in FIG. 2 and Table 2, Examples showed a remarkably improved chip crushability.

On the other hand, samples No. 8 and No. 11 in Comparative Examples contained a small amount of Ni and Al and could be hardly hardened by aging. Also, sample No. 9 in Comparative Examples was inferior in magnetic material properties due to magnetic flux density B25 of lower than 1 tesla and high coercivity. This is because the Ni content in sample No. 9 is so high that it is significantly affected by the austenite stabilization element. Comparative Example No. 10 was excellent in machinability, hardness, and magnetic properties but poor in corrosion resistance due to absence of elements such as Ti and Zr that strongly fix C and S. Comparative example No. 12 had sufficient characteristics but was poor in chip crushability due to absence of Bi.

Thus, the present invention makes it possible to provide a material that has a higher cutting chip crushability than of conventional precipitation hardening type soft magnetic ferritic stainless steels. The material has a hardness, magnetic properties, and corrosion resistance equivalent to those of the conventional materials and can be suitably applied to magnetic core materials for various solenoid valves, electronically controlled fuel injection devices, and the like. The productivity improved by the imparted chip processability leads to reduction of the manufacturing cost and thus greatly contributes to the industry.

### REFERENCE SIGNS LIST

1: Cutting resistance
2: Thrust force
3: Feed force
4: Principal cutting force

1. A precipitation hardening type soft magnetic ferritic stainless steel having an excellent machinability, containing, in % by mass,
C: 0.1% or less (excluding 0%),
Si: 0.01 to 2.5%,
Mn: 0.5% or less (excluding 0%),
S: 0.1% or less (excluding 0%),
Cr: 12.0 to 19.0%,
Ni: 1.0 to 4.0%,
Al: 0.5 to 3.0%, and
at least one of Ti: 0.05 to less than 0.5% and Zr: 0.05 to less than 0.3%, as well as
Bi: 0.02 to 0.5%, wherein
a remainder contains inevitable impurities and substantially consists of Fe, and the stainless steel has a structure substantially in a ferrite phase after solution annealing and aging, and a hardness of 300 Hv or higher after aging.

2. A precipitation hardening type soft magnetic ferritic stainless steel having excellent machinability, containing, in % by mass,
C: 0.1% or less (excluding 0%),
Si: 0.01 to 2.5%,
Mn: 0.5% or less (excluding 0%),
S: 0.1% or less (excluding 0%),
Cr: 12.0 to 19.0%,
Ni: 1.0 to 4.0%,
Al: 0.5 to 3.0%, and
at least one of Ti: 0.05 to less than 0.5% and Zr: 0.05 to less than 0.3%, as well as
Bi: 0.02 to 0.5%,
and further contains
at least one of Nb: 1.0% or less, Mo: 4.0% or less, Cu: 2.0% or less, B: 0.01% or less, and REM: 0.1% or less, wherein
the remainder contains inevitable impurities and substantially consists of Fe, and the stainless steel has a structure substantially in a ferrite phase after solution annealing and aging, and a hardness of 300 Hv or higher after aging.
